(19) United States
(12) Patent Application Publication
(10) Pub. No.: US 2006/0169865 A1
(43) Pub. Date: Aug. 3, 2006

(54) Christmas tree stand with scaled train track

(76) Inventor: David Mark Solak, Seven Hills, OH (US)

Correspondence Address: David Mark Solak, 4805 Maple Hill Drive, Seven Hills, OH, 44131-5916, US

(21) Appl. No.: 11/046,909

(22) Filed: Jan. 31, 2005

(51) Int. Cl. F16M 13/00

(52) U.S. Cl. 248/523

(57) ABSTRACT

With this invention, a Christmas tree can be held with stability in an upright position. The base will provide a track molded into the base for battery-operated trains or a track that is affixed to the base providing the electricity needed through metallic rails. The tree can be a cut live tree or a plastic replica tree. The scale of the track or train is only limited to a practical size of the base.

### FIELD OF INVENTION

The invention described in this document intends to give a stable, simple platform to hold a Christmas tree in a vertical position, hold water for a live tree, and provide a scaled track to run a model train around the perimeter of the platform or base. The design of this base intends to support two types of rail trains: The electric train such as an HO gauge type that receives it's electric current through the rails or a more toy-like train that runs on batteries and a plastic non-conductive rail. The base may be fitted with a conductive metal-railed track or a track that is molded into the base. The conductive-rail type track would use a transformer to power the scaled locomotive through the locomotive's wheels. The plastic model track will not require a transformer since the locomotive would be powered by batteries located onboard. The scale of the track and train is only limited by the practical size of the base. The base would not be limited to just live trees. The design could also support a non-living replica tree.

### DESCRIPTION OF PRIOR ART

There are many patents relating to Christmas tree stands. Only a few have implemented scale model rail trains. In April of 1938 a patent was issued to Jarnagin, U.S. Pat. No. 2,190,544. One must consider the technology of the times. The design in this patent would be heavy and somewhat complicated for what it is achieving. A metal frame is incorporated to allow the tree to stand while providing a fixture for the materials used to make a topographical environment. Scale structures are provided also. He intends to use wire mesh and a canvas material for part of the construction. The invention claimed in this document is not meant to be as complex. While some hills or trees could be molded into the base, the invention described in this article intends to give a simpler more practical appearance. Again, one must consider the historical period when the next patent was issued. U.S. Pat. No. 2,874,496 was issued Feb. 24, 1959. to Lee L. Rakes. This patent is somewhat complex in operation and construction. The invention utilizes audio equipment and snow scenes while incorporating a variety of electronic components of the day. Stepping switches and relays are utilized to operate a multiple of electric-based devices including a tree-rotating motor. The invention claimed in this document intends to accomplish three basic operations: One, Hold the tree in a vertical upright position. Two, Hold water for the tree if a live tree is desired. Three, Provide a track for electric trains to run.

### SUMMARY OF THE INVENTION

This invention intends to hold a Christmas tree in a stable upright position while providing a reservoir or recess for holding water to keep the tree as fresh as possible if a live tree is used. Another characteristic of this invention is: a track for scale model trains to run on. The track can be molded into the base in plastic for battery-operated locomotives. The track can be affixed to the base for track-powered locomotives. An aesthetic effect is: allowing a model train to run around the tree for a desirable and entertaining action.

### BRIEF DESCRIPTION OF DRAWINGS

FIG. 1. Shows the base from above with the track running circular.

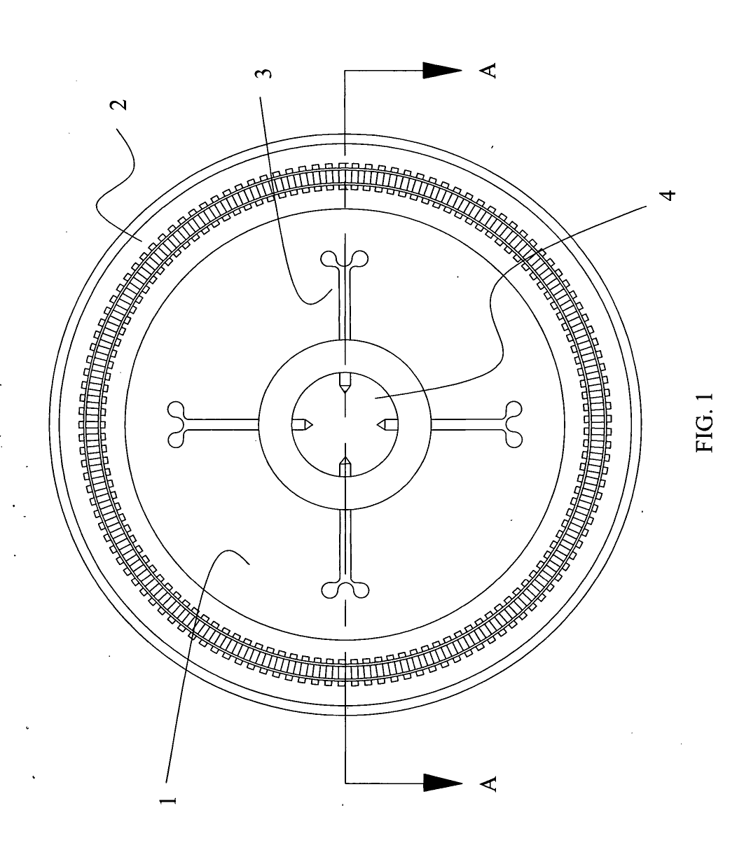

FIG. 2. Shows a cross-section view of the base revealing the contours.

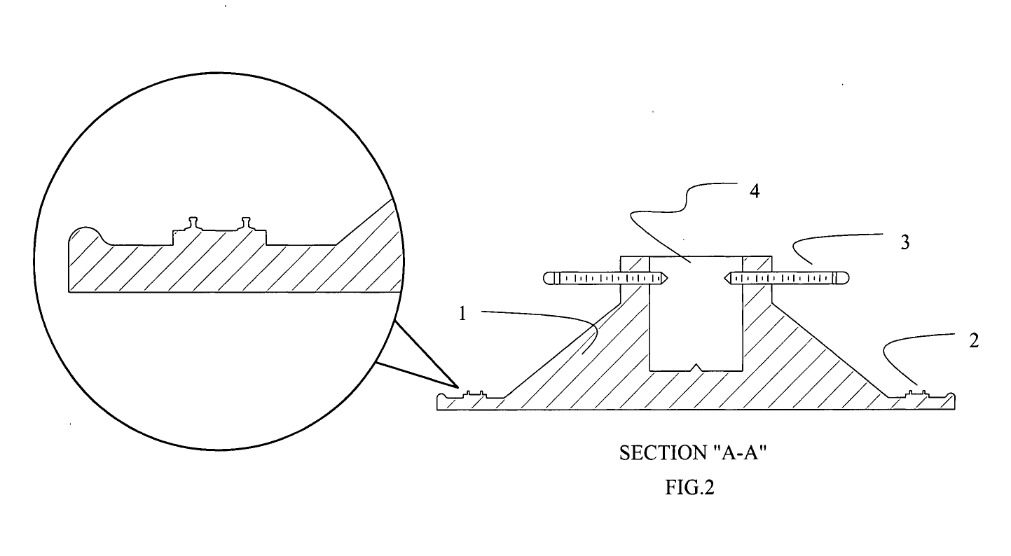

### DETAILED DESCRIPTION OF DRAWINGS

A base 1 supports a Christmas tree by providing a deep well reservoir or recess 4. A multiple of threaded rods 3 are provided to pinch the tree trunk for stability. A track 2 can be molded into the base 1 or affixed to the base 1 for rail supplied electrical current.

I claim:

1. A Christmas-tree-holding base comprising;
a. A recess to allow the tree to be held vertically and,
b. A means to pinch the tree trunk securely into the said recess
c. Track to allow the operation of scale model trains around the base.
